(19) United States
(12) Patent Application Publication
(10) Pub. No.: US 2019/0359799 A1
(43) Pub. Date: Nov. 28, 2019

(54) TIRE COMPRISING A RUBBER COMPOSITION COMPRISING A POLYMER BEARING A CONJUGATED DIENE GROUP CROSSLINKED BY A DIENOPHILE

(71) Applicant: COMPAGNIE GENERALE DES ETABLISSEMENTS MICHELIN, Clermont-Ferrand (FR)

(72) Inventors: Etienne FLEURY, Clermont-Ferrand Cedex 9 (FR); Bênoit SCHNELL, Clermont-Ferrand Cedex 9 (FR); Adeline JASSELIN, Clermont-Ferrand Cedex 9 (FR)

(73) Assignee: COMPAGNIE GENERALE DES ETABLISSEMENTS MICHELIN, Clermont-Ferrand (FR)

(21) Appl. No.: 16/470,374

(22) PCT Filed: Dec. 4, 2017
(86) PCT No.: PCT/FR2017/053379

§ 371 Date: Jul. 15, 2019

(30) Foreign Application Priority Data
Dec. 15, 2016 (FR) 1662520

(51) Int. Cl. C08L 9/06; C08L 91/06; C08K 5/09; C08K 3/06; C08K 3/36; C08K 3/08; C08K 5/3415; C08K 5/00; B60C 1/00

(52) U.S. Cl. CPC C08L 9/06; C08L 91/06; C08K 5/09; C08K 3/06; C08K 2003/2296; C08K 3/08; C08K 5/3415; C08K 5/0025; B60C 1/00; C08K 3/36

(57) ABSTRACT

The present invention relates to a tire comprising a rubber composition based on at least a reinforcing filler, a polymer comprising conjugated diene functions and a system for crosslinking the polymer. The system for crosslinking the polymer comprises a polydienophile of general formula (I):

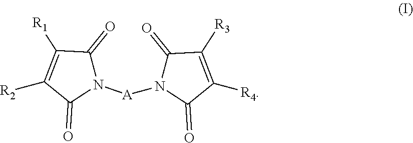

According to formula (I), A represents a covalent bond or a hydrocarbon-based group comprising at least 1 carbon atom, which is optionally substituted and optionally interrupted by one or more heteroatoms, and R₁, R₂, R₃ and R₄ independently represent identical or different groups chosen from the hydrogen atom and hydrocarbon-based groups, R₁ and R₂ on the one hand and R₃ and R₄ on the other hand possibly forming, together with the carbon atoms of the ring to which they are attached, a ring.

This application is a 371 national phase entry of PCT/FR2017/053379 filed on 4 Dec. 2017, which claims benefit of French Patent Application No. 1662520, filed 15 Dec. 2016, the entire contents of which are incorporated herein by reference for all purposes.

### BACKGROUND

### 1. Technical Field

The present invention relates to tires provided with rubber compositions, in particular with rubber compositions based on polymers comprising conjugated diene functions.

### 2. Related Art

Since fuel savings and the need to protect the environment have become a priority, it has proved necessary to produce tires having a rolling resistance which is as low as possible. This has been made possible in particular by virtue of the use, in rubber compositions, of specific inorganic fillers capable of rivaling, from a reinforcing perspective, an organic filler such as a conventional tire-grade carbon black, while offering these compositions a lower hysteresis, which is synonymous with a lower rolling resistance for the tires comprising them.

Further reducing the rolling resistance remains, in the current economic and ecological context, an ongoing concern despite the low levels respectively achieved both with specific inorganic fillers described as “reinforcing” and with a carbon black. Many avenues have already been explored in order to further lower the hysteresis of the rubber compositions reinforced with such reinforcing fillers. Nevertheless, it still remains advantageous to pursue an objective of lowering the consumption of the vehicles, which lowering can result from an improvement in the hysteresis properties of the tire compositions.

Furthermore, it is known, and has been normal for a great many years, to use, in tires, rubber compositions having an elastomer matrix which is crosslinked with sulfur; this crosslinking is then known as vulcanization. The conventional vulcanization system combines molecular sulfur and at least one vulcanization accelerator. However, it is known that such a system is damaging to the processing of the composition before curing by the scorching phenomenon. It will be recalled that the “scorching” phenomenon rapidly results, during the preparation of the rubber compositions, in premature vulcanizations (“scorching”), in very high viscosities in the raw state, and finally in rubber compositions which are virtually impossible to work and to process industrially.

Consequently, the vulcanization systems have been improved over the years, in combination with the processes for the preparation of the rubber compositions, in order to overcome the abovementioned disadvantages. Thus, the compositions are often complex and comprise, in addition to the molecular sulfur or an agent which donates molecular sulfur, vulcanization accelerators, activators and optionally vulcanization retarders. At present, it would be advantageous for manufacturers to find crosslinking systems which are as effective as vulcanization, while simplifying the compositions and their preparation.

Furthermore, it is also known to use, in some parts of the tires, rubber compositions having high stiffness during small strains of the tire (cf. WO 02/110269). Resistance to small strains is one of the properties which a tire has to exhibit in order to respond to the stresses to which it is subjected.

This stiffening can be obtained by increasing the content of reinforcing filler or by incorporating certain reinforcing resins in the constituent rubber compositions of the parts of the tire.

However, in a known way, increasing the stiffness of a rubber composition by increasing the content of filler may detrimentally affect the hysteresis properties and thus the rolling resistance properties of tires. In point of fact, it is an ongoing aim to lower the rolling resistance of tires in order to reduce the consumption of fuel, for economic and environmental purposes.

### SUMMARY

While pursuing their research, the applicants have now found that specific compositions for tires can be prepared in a simplified manner, compared to conventional compositions, while retaining, or even improving, their stiffness properties.

Consequently, a first subject of the invention relates to a tire comprising a rubber composition based on at least a reinforcing filler, a polymer comprising conjugated diene functions and a system for crosslinking said polymer comprising a polydienophile of general formula (I):

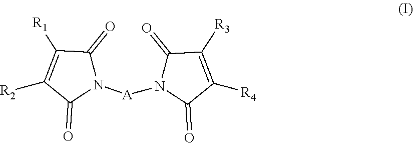

in which:
A represents a covalent bond or a hydrocarbon-based group comprising at least 1 carbon atom, which is optionally substituted and optionally interrupted by one or more heteroatoms,
R₁, R₂, R₃ and R₄ independently represent identical or different groups chosen from the hydrogen atom and hydrocarbon-based groups, R₁ and R₂ on the one hand and R₃ and R₄ on the other hand possibly forming, together with the carbon atoms of the ring to which they are attached, a ring.

### DETAILED DESCRIPTION OF EXAMPLE EMBODIMENTS

The tires in accordance with the invention are especially intended for passenger vehicles as well as for two-wheel vehicles (motorcycles, bicycles), industrial vehicles chosen from vans, “heavy-duty” vehicles—i.e. underground, bus, heavy road transport vehicles (lorries, tractors, trailers), off-road vehicles, heavy agricultural vehicles or earthmoving equipment, aircraft, and other transportation or handling vehicles.

The invention and its advantages will be easily understood in the light of the following description and exemplary embodiments.

I. Composition of the Tires of the Invention

The tire according to the invention comprises a rubber composition based on at least a reinforcing filler, a polymer comprising conjugated diene functions and a system for crosslinking said polymer comprising a polydienophile of general formula (I).

The expression “composition based on” should be understood as meaning a composition comprising the mixture and/or the reaction product of the various constituents used, some of these base constituents being capable of reacting or intended to react with one another, at least in part, during the various phases of production of the composition, in particular during the crosslinking or vulcanization thereof.

The expression “molar equivalent”, which is well known to those skilled in the art, should be understood as meaning the quotient of the number of moles of the compound concerned to the number of moles of the reference compound. Thus, 2 equivalents of a compound B relative to a compound A represent 2 mol of the compound B when 1 mol of the compound A is used.

When reference is made to a “predominant” compound, this is understood to mean, within the meaning of the present invention, that this compound is predominant among the compounds of the same type in the composition, that is to say that it is the one which represents the greatest amount by weight among the compounds of the same type. Thus, for example, a predominant polymer is the polymer representing the greatest weight relative to the total weight of the polymers in the composition. In the same way, a “predominant” filler is the one representing the greatest weight among the fillers of the composition. By way of example, in a system comprising just one polymer, the latter is predominant within the meaning of the present invention and, in a system comprising two polymers, the predominant polymer represents more than half of the weight of the polymers.

On the contrary, a “minor” compound is a compound which does not represent the greatest fraction by weight among the compounds of the same type.

In the present description, unless expressly indicated otherwise, all the percentages (%) shown are percentages (%) by weight. Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

The compounds mentioned in the description can be of fossil or biobased origin. In the latter case, they may partially or completely result from biomass or be obtained from renewable starting materials resulting from biomass. Polymers, plasticizers, fillers, and the like, are concerned in particular.

I.1. Polymer Comprising Conjugated Diene Functions

“Polymer comprising conjugated diene functions” is understood to mean any type of polymer within the meaning known to those skilled in the art, whether it is thermoplastic or elastomeric in nature and whether it is a resin or an elastomer, provided that this polymer bears conjugated diene functional groups.

The compositions of the invention may contain just one polymer comprising conjugated diene functions or a mixture of several polymers comprising conjugated diene functions.

The polymer comprising conjugated diene functions may preferably be selected from the group consisting of thermoplastic polymers, resins, elastomers and the mixtures of the latter. Preferentially, the polymer comprising conjugated diene functions is selected from the group consisting of thermoplastic polymers comprising conjugated diene functions, elastomers comprising conjugated diene functions and mixtures thereof.

The “conjugated diene” function is well known to those skilled in the art and implies the presence of two successive carbon-carbon double bonds on the polymer, which may be located either along the polymer chain or on a branch of the polymer chain, in which case reference is made to a pendant function.

This conjugated diene function may especially be from furan-type rings (i.e. furan and the substituted derivatives thereof), anthracene-type rings (i.e. anthracene and the substituted derivatives thereof), cyclopentadiene-type rings (i.e. cyclopentadiene and the substituted derivatives thereof, especially fulvenes), pyrrole-type rings (i.e. pyrrole and the substituted derivatives thereof), or else thiophene-type rings (i.e. thiophene and the substituted derivatives thereof).

Thus, preferably for the invention, the conjugated diene function is selected from the group consisting of furans (i.e. furan and the substituted derivatives thereof), anthracenes (i.e. anthracene and the substituted derivatives thereof), cyclopentadienes (i.e. cyclopentadiene and the substituted derivatives thereof, especially fulvenes), pyrroles (i.e. pyrrole and the substituted derivatives thereof), thiophenes (i.e. thiophene and the substituted derivatives thereof) and the mixtures thereof.

More preferentially, the conjugated diene function is selected from the group consisting of furans (i.e. furan and the substituted derivatives thereof), anthracenes (i.e. anthracene and the substituted derivatives thereof), cyclopentadienes (i.e. cyclopentadiene and the substituted derivatives thereof, especially fulvenes) and the mixtures thereof.

More preferably, the conjugated diene function is selected from the group consisting of furan, anthracene, cyclopentadiene, fulvene and mixtures thereof.

These polymers comprising conjugated diene functions may be obtained by the polymerization of monomers having such conjugated diene functions, as long as the polymerization reaction does not involve these conjugated diene functions and leaves them intact at the end of the polymerization. These monomers may for example be substituted (meth)acrylates, for instance furfuryl methacrylate.

These polymers comprising conjugated diene functions may also be obtained by post-polymerization functionalization, by any means making it possible to obtain a conjugated diene function as described above on the polymer.

Preferably, the polymer comprising conjugated diene functions is an elastomer comprising conjugated diene functions.

Elastomer or rubber (the two terms being, as is known, synonymous and interchangeable) comprising conjugated diene functions is understood to mean any type of elastomer within the meaning known to those skilled in the art, whether a homopolymer or a block, statistical or other copolymer, having elastomeric properties, comprising conjugated diene functional groups as defined above.

The elastomers are, as is known, solid at ambient temperature (20° C.); solid is understood to mean any substance not having the ability to eventually assume, at the latest after 24 hours, solely under the effect of gravity and at ambient temperature (20° C.), the shape of the container in which it is present.

The Tg of the elastomers described below is measured in a known way by DSC (Differential Scanning Calorimetry), for example and unless specifically indicated otherwise in the present application according to Standard ASTM D3418 of 1999.

The elastomer comprising conjugated diene functions may be selected from the group consisting of diene elastomers comprising conjugated diene functional groups, olefinic elastomers comprising conjugated diene functional groups and mixtures thereof. Preferentially, the elastomer comprising conjugated diene functions is selected from olefinic elastomers comprising conjugated diene functional groups and mixtures thereof. According to another preferential variant of the invention, the elastomer comprising conjugated diene functions is selected from diene elastomers comprising conjugated diene functional groups and mixtures thereof.

It is recalled that elastomer of olefinic type comprising conjugated diene functions should be understood to mean an elastomer comprising conjugated diene functional groups, the elastomeric chain of which is a carbon-based chain predominantly comprising olefin monomer units denoted O (molar content of greater than 50%). More specifically, the molar content of O is between 50 and 95%, preferentially between 65 and 85%. This olefinic elastomer is therefore a copolymer also comprising 5 to 50 mol % of non-olefinic units, that is to say units other than O. These non-olefinic units consist partially or entirely of units comprising conjugated diene functional groups, denoted R, necessary for the requirements of the invention. In the case in which not all the non-olefinic units are R units, other units, which are non-diene and non-olefinic, denoted A′, are present in the carbon-based chain in such a way that the molar content of R+A′ is strictly less than 50%.

The monomers O can originate from any olefin known to those skilled in the art, for instance ethylene, propylene, butylene or isobutylene, these monomers optionally being substituted by linear or branched alkyl groups.

Preferentially, O is an ethylene [—CH₂—CH₂—] unit and, in this preferential case, the olefinic elastomer comprising conjugated diene functions is an ethylenic elastomer comprising conjugated diene functions, which makes it possible to even further improve the compromise between the stiffness and hysteresis performances in the tire compositions.

An essential characteristic of the olefinic elastomer comprising conjugated diene functions of use for the requirements of the invention is that it is functionalized, comprising conjugated diene functional groups.

The conjugated diene function may be borne directly by the carbon-based backbone or may also be pendant and is then already present in a monomer involved in the copolymerization with the olefin (this monomer may for example be furfuryl (meth)acrylate).

The content (mol %) of R units in the olefinic elastomers comprising conjugated diene functional groups described above can vary to a great extent depending on the specific embodiments of the invention, preferably within a range from 0.1% to 50%, preferentially within a range from 0.2% to 50%, more preferentially within a range from 0.2% to 30% and better still within a range from 0.2% to 20%. When the content of R units is less than 0.1%, there is a risk of the targeted technical effect being insufficient whereas, above 50%, the elastomer would no longer be predominantly olefinic.

When the non-olefinic units are not composed entirely of R units comprising conjugated diene functions, other non-olefinic units A′ are present in the chain, so that the total molar content represented by the monomers O, R and A′ is equal to 100%. The non-olefinic monomers of use in the preparation of the olefinic elastomers comprising conjugated diene functional groups can be chosen from non-olefinic monomers not resulting in unsaturations and monomers which, once polymerized, result in unsaturations borne by the elastomer chain (other than diene monomers).

The non-olefinic monomers not resulting in unsaturations are essentially vinyl and acrylic/methacrylic monomers. For example, such monomers can be chosen from styrene, vinyl acetate, vinyl alcohol, acrylonitrile, methyl acrylate or methyl methacrylate, these monomers optionally being substituted by alkyl or aryl groups or other functionalized groups.

For example also, the non-diene monomers of use in the preparation of the elastomers of olefinic type bearing unsaturations by copolymerization are all those known to those skilled in the art for forming unsaturated elastomers, for instance dicyclopentadienyloxyethyl methacrylate.

The olefinic elastomers comprising conjugated diene functional groups have a Tg which in the very great majority of cases is negative (that is to say, less than 0° C.).

The olefinic elastomers comprising conjugated diene functional groups have a number-average molar mass (Mₙ) of at least 10 000 g/mol, preferentially of at least 15 000 g/mol, and of at most 1 500 000 g/mol. The polydispersity index PI, equal to M_{w}/Mₙ (M_{w} being the weight-average molar mass), is between 1.05 and 11.00.

Preferably, and in summary, the olefinic elastomer comprising conjugated diene functions is thus a copolymer having at least 50% (in moles) of olefin monomer units and with a number of different monomer units of greater than or equal to 2, preferentially from 2 to 5 and more preferentially 2 or 3. This polymer may be obtained by copolymerization.

It is recalled that elastomer of the diene type comprising conjugated diene functions should be understood as meaning an elastomer, whether natural or synthetic, which results at least in part (i.e., a homopolymer or a copolymer) from diene monomers (monomers bearing two conjugated or non-conjugated carbon-carbon double bonds), this polymer being conjugated diene-functionalized, that is to say that it comprises conjugated diene functions.

Given these definitions, diene elastomer capable of being used in the compositions in accordance with the invention is understood more particularly to mean:

(a)—any homopolymer of a conjugated diene monomer, especially any homopolymer obtained by polymerization of a conjugated diene monomer having from 4 to 12 carbon atoms;
(b)—any copolymer obtained by copolymerization of one or more conjugated dienes with one another or with one or more vinylaromatic compounds having from 8 to 20 carbon atoms;
(c)—any ternary copolymer obtained by copolymerization of ethylene and of an α-olefin having from 3 to 6 carbon atoms with a non-conjugated diene monomer having from 6 to 12 carbon atoms, for instance the elastomers obtained from ethylene and propylene with a non-conjugated diene monomer of the abovementioned type, such as, in particular, 1,4-hexadiene, ethylidenenorbomene or dicyclopentadiene;
(d)—any copolymer of isobutene and of isoprene (butyl rubber) and also the halogenated versions, in particular chlorinated or brominated versions, of this type of copolymer,
(e)—any copolymer obtained by copolymerization of one or more conjugated dienes with ethylene, an acyclic aliphatic α-monoolefin having from 3 to 18 carbon atoms or their mixture, for instance those described in the documents WO 2005/028526, WO 2004/035639 and WO 2007/054224;
(f)—any copolymer obtained by copolymerization of one or more conjugated dienes with an ester of (meth)acrylic acid, (meth)acrylonitrile or the mixture thereof.

The following are especially suitable as conjugated dienes: 1,3-butadiene, 2-methyl-1,3-butadiene, 2,3-di(C₁-C₅ alkyl)-1,3-butadienes, for instance 2,3-dimethyl-1,3-butadiene, 2,3-diethyl-1,3-butadiene, 2-methyl-3-ethyl-1,3-butadiene or 2-methyl-3-isopropyl-1,3-butadiene, an aryl-1,3-butadiene, 1,3-pentadiene or 2,4-hexadiene.

The following, for example, are suitable as vinylaromatic compounds: styrene, ortho-, meta- or para-methylstyrene, the “vinyltoluene” commercial mixture, para-(tert-butyl)styrene, methoxystyrenes, chlorostyrenes, vinylmesitylene, divinylbenzene or vinylnaphthalene.

By way of acyclic aliphatic α-monoolefins having from 3 to 18 carbon atoms, mention may be made of propene, butene, hexene, octene and hexadecene.

The following, for example, are suitable as esters of (meth)acrylic acid: alkyl (meth)acrylates having 1 to 12 carbon atoms, such as methyl, ethyl, propyl, butyl, hexyl or octyl (meth)acrylate.

Preferentially, the diene elastomer is selected from the group consisting of polybutadienes, polyisoprenes, butadiene copolymers, isoprene copolymers and mixtures thereof. Such copolymers are more preferentially selected from the group consisting of butadiene/styrene copolymers (SBRs), isoprene/butadiene copolymers (BIRs), isoprene/styrene copolymers (SIRs), isoprene/butadiene/styrene copolymers (SBIRs) and copolymers of ethylene and of butadiene (EBRs).

An essential characteristic of the diene elastomer comprising conjugated diene functions of use for the requirements of the invention is that it is functionalized, bearing conjugated diene functional groups.

The conjugated diene functions present in the diene elastomer may be obtained by any means. For example, the elastomer may be prepared by modification of a first diene elastomer with a modifying agent bearing a conjugated diene unit as defined above, and a function that reacts with the carbon-carbon double bonds of the first diene elastomer. The conjugated diene unit may be directly linked, or linked via a spacer, to the reactive function. Spacer is intended to mean an atom or a group of atoms.

According to a preferential variant of the invention, the polymer comprising conjugated diene functions is a diene elastomer comprising conjugated diene functions. In this preferred variant, the diene elastomer is preferentially a polyisoprene, a polybutadiene, a butadiene/styrene copolymer (SBR) or an ethylene/butadiene copolymer (EBR). In this preferred variant, the conjugated diene function is borne by a furan, anthracene, cyclopentadiene, fulvene, pyrrole or else thiophene group. More preferentially, the conjugated diene function is borne by a furan, anthracene, cyclopentadiene, or fulvene group. Very preferentially, the conjugated diene function is borne by a furan or anthracene group, and more preferentially still an anthracene group.

According to a preferential embodiment of the invention, the rubber composition comprises, for example, from 30 to 100 phr, in particular from 50 to 100 phr and preferably from 70 to 100 phr of elastomer comprising conjugated diene functions as a blend with from 0 to 70 phr, in particular from 0 to 50 phr and preferably from 0 to 30 phr of one or more other elastomers, all elastomers known to those skilled in the art being usable.

According to another preferential embodiment of the invention, the composition comprises, for the whole of the 100 phr of elastomer, one or more elastomers comprising conjugated diene functions.

I.2. Reinforcing Filler

Use may be made of any type of reinforcing filler known for its abilities to reinforce a rubber composition which can be used in the manufacture of tires, for example an organic filler, such as carbon black, a reinforcing inorganic filler, such as silica, or else a blend of these two types of filler, in particular a blend of carbon black and of silica.

All carbon blacks, especially blacks of the HAF, ISAF or SAF type, conventionally used in tires (“tire-grade” blacks) are suitable as carbon blacks. Mention will more particularly be made, among the latter, of the reinforcing carbon blacks of the 100, 200 or 300 series (ASTM grades), such as, for example, the N115, N134, N234, N326, N330, N339, N347 or N375 blacks, or else, depending on the applications targeted, the blacks of higher series (for example N660, N683 or N772). The carbon blacks might, for example, be already incorporated in an isoprene elastomer in the form of a masterbatch (see, for example, Applications WO 97/36724 or WO 99/16600).

Mention may be made, as examples of organic fillers other than carbon blacks, of functionalized polyvinyl organic fillers, such as described in applications WO-A-20061069792, WO-A-2006/069793, WO-A-2008/003434 and WO-A-2008/003435.

“Reinforcing inorganic filler” should be understood, in the present application, by definition, as meaning any inorganic or mineral filler (regardless of its colour and its origin, natural or synthetic), also known as “white filler”, “dear filler” or indeed even “non-black filler”, in contrast to carbon black, capable of reinforcing by itself alone, without means other than an intermediate coupling agent, a rubber composition intended for the manufacture of tires, in other words capable of replacing, in its reinforcing role, a conventional tire-grade carbon black; such a filler is generally characterized, in a known way, by the presence of hydroxyl

(—OH) groups at its surface.

The physical state in which the reinforcing inorganic filler is provided is not important, whether it is in the form of a powder, of micropearls, of granules, of beads or any other appropriate densified form. Of course, reinforcing inorganic filler is also understood to mean mixtures of different reinforcing inorganic fillers, in particular of highly dispersible siliceous and/or aluminous fillers, such as described below.

Mineral fillers of the siliceous type, especially silica (SiO₂), or of the aluminous type, especially alumina (Al₂O₃), are suitable in particular as reinforcing inorganic fillers. The silica used can be any reinforcing silica known to those skilled in the art, especially any precipitated or fumed silica exhibiting a BET specific surface area and a CTAB specific surface area both of less than 450 m²/g, preferably from 30 to 400 m²/g. Mention will be made, as highly dispersible precipitated silicas (“HDSs”), for example, of the Ultrasil 7000 and Ultrasil 7005 silicas from Degussa, the Zeosil 1165MP, 1135MP and 1115MP silicas from Rhodia, the Hi-Sil EZ150G silica from PPG, the Zeopol 8715, 8745 and 8755 silicas from Huber or the silicas with a high specific surface area as described in application WO 03/116837.

The reinforcing inorganic filler used, in particular if it is silica, preferably has a BET specific surface area of between 45 and 400 m²/g, more preferentially of between 60 and 300 m²/g.

Preferentially, the content of total reinforcing filler (carbon black and/or reinforcing inorganic filler, such as silica) is between 20 and 200 phr, more preferentially between 30 and 150 phr, the optimum being, as is known, different depending on the specific applications targeted: the level of reinforcement expected for a bicycle tire, for example, is of course less than that required for a tire capable of running at high speed in a sustained manner, for example a motorcycle tire, a tire for a passenger vehicle or a tire for a utility vehicle, such as a heavy-duty vehicle.

According to a preferential embodiment of the invention, use is made of a reinforcing filler comprising between 30 and 150 phr, more preferentially between 50 and 120 phr, of organic filler, particularly of carbon black, and optionally silica; the silica, when it is present, is preferably used at a content of less than 20 phr, more preferentially of less than 10 phr (for example between 0.1 and 10 phr). This preferential embodiment is particularly preferred when the predominant elastomer of the composition is an epoxidized isoprene rubber, more particularly epoxidized natural rubber.

Alternatively, according to another preferential embodiment of the invention, use is made of a reinforcing filler comprising between 30 and 150 phr, more preferentially between 50 and 120 phr, of inorganic filler, particularly of silica, and optionally carbon black; the carbon black, when it is present, is preferably used at a content of less than 20 phr, more preferentially of less than 10 phr (for example between 0.1 and 10 phr). This preferential embodiment is also particularly preferred when the predominant elastomer of the composition is an epoxidized isoprene rubber, more particularly epoxidized natural rubber.

In order to couple the reinforcing inorganic filler to the diene elastomer, use may be made, in a known way, of an at least bifunctional coupling agent (or bonding agent) intended to provide a satisfactory connection, of chemical and/or physical nature, between the inorganic filler (surface of its particles) and the diene elastomer, in particular bifunctional organosilanes or polyorganosiloxanes.

Use may be made especially of silane polysulfides, referred to as “symmetrical” or “asymmetrical” depending on their specific structure, such as described, for example, in applications WO 03/002648 (or US 2005/016651) and WO 03/002649 (or US 2005/016650).

Suitable in particular, without the definition below being limiting, are silane polysulfides referred to as “symmetrical”, corresponding to the following general formula (I):

Z-A-Sx-A-Z, in which: (I)
x is an integer from 2 to 8 (preferably from 2 to 5);
A is a divalent hydrocarbon-based radical (preferably C₁-C₁₈ alkylene groups or C₆-C₁₂ arylene groups, more particularly C₁-C₁₀ alkylenes, in particular C₁-C₄ alkylenes, especially propylene);
Z corresponds to one of the formulae below:

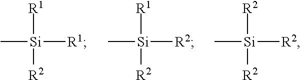

in which:
the R¹ radicals, which are substituted or unsubstituted and identical to or different from one another, represent a C₁-C₁₈ alkyl, C₅-C₁₈ cycloalkyl or C₆-C₁₈ aryl group (preferably C₁-C₆ alkyl, cyclohexyl or phenyl groups, especially C₁-C₄ alkyl groups, more particularly methyl and/or ethyl).
the R² radicals, which are substituted or unsubstituted and identical to or different from one another, represent a C₁-C₁₈ alkoxy or C₅-C₁₈ cycloalkoxy group (preferably a group chosen from C₁-C₈ alkoxys and C₅-C₈ cycloalkoxys, more preferentially still a group chosen from C₁-C₄ alkoxys, in particular methoxy and ethoxy).

In the case of a mixture of alkoxysilane polysulfides corresponding to the above formula (I), especially customary commercially available mixtures, the mean value of “x” is a fractional number preferably of between 2 and 5, more preferentially close to 4. However, the invention may also advantageously be performed, for example, with alkoxysilane disulfides (x=2).

Mention will more particularly be made, as examples of silane polysulfides, of bis((C₁-C₄)alkoxy(C₁-C₄)alkylsilyl(C₁-C₄)alkyl) polysulfides (especially disulfides, trisulfides or tetrasufides), such as, for example, bis(3-trimethoxysilylpropyl) or bis(3-triethoxysilylpropyl) polysulfides. Among these compounds, use is made in particular of bis(3-triethoxysilylpropyl) tetrasulfide, abbreviated to TESPT, of formula [(C₂H₅O)₃Si(CH₂)₃S₂]₂, or bis(triethoxysilylpropyl) disulfide, abbreviated to TESPD, of formula [(C₂H₅O)₃Si(CH₂)₃S]₂. Mention will also be made, as preferential examples, of bis(mono(C₁-C₄)alkoxydi(C₁-C₄)alkylsilylpropyl) polysulfides (especially disulfides, trisulfides or tetrasulfides), more particularly bis(monoethoxydimethylsilylpropyl) tetrasulfide, such as described in patent application WO 02/083782 (or US 2004/132880).

Mention will especially be made, as coupling agent other than alkoxysilane polysulfide, of bifunctional POSs (polyorganosiloxanes) or else of hydroxysilane polysulfides (R²═OH in the above formula I), such as described in patent applications WO 02/30939 (or U.S. Pat. No. 6,774,255) and WO 02/31041 (or US 2004/051210), or else of silanes or POSs bearing azodicarbonyl functional groups, such as described, for example, in patent applications WO 2006/125532, WO 2006/125533 and WO 2006/125534.

In the rubber compositions in accordance with the invention, the content of coupling agent is preferentially between 4 and 12 phr, more preferentially between 4 and 8 phr.

Those skilled in the art will understand that, as filler equivalent to the reinforcing inorganic filler described in the present section, a reinforcing filler of another nature, especially organic nature, might be used provided that this reinforcing filler is covered with an inorganic layer such as silica or else comprises functional sites, especially hydroxyl sites, at its surface requiring the use of a coupling agent in order to form the bond between the filler and the elastomer.

I.3. Polydienophile

The polymer comprising conjugated diene functions and the reinforcing filler described above are combined with a crosslinking system capable of crosslinking or curing the composition of the tire according to the invention. This crosslinking system comprises a (i.e. at least one) polydienophile of general formula (I)

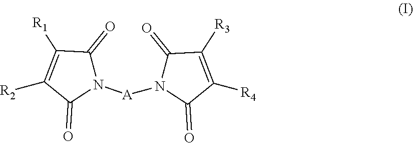

in which:
A represents a covalent bond or a hydrocarbon-based group comprising at least 1 carbon atom, which is optionally substituted and optionally interrupted by one or more heteroatoms,
R₁, R₂, R₃ and R₄ independently represent identical or different groups chosen from the hydrogen atom and hydrocarbon-based groups, R₁ and R₂ on the one hand and R₃ and R₄ on the other hand possibly forming, together with the carbon atoms of the ring to which they are attached, a ring.

Preferably, in the polydienophile of general formula (I), A represents a covalent bond or a divalent hydrocarbon-based group comprising from 1 to 1800 carbon atoms, preferentially from 2 to 300 carbon atoms, more preferentially from 2 to 100 carbon atoms and very preferentially from 2 to 50 carbon atoms. Above 1800 carbon atoms, the polydienophile is a less effective crosslinking agent. Thus, A preferably represents a divalent hydrocarbon-based group comprising from 3 to 50 carbon atoms, preferentially from 5 to 50 carbon atoms, more preferentially from 8 to 50 carbon atoms and more preferentially still from 10 to 40 carbon atoms.

Preferentially, A is a divalent group of aliphatic or aromatic type or a group comprising at least an aliphatic portion and an aromatic portion, and preferably a divalent group of aromatic type or a group comprising at least an aliphatic portion and an aromatic portion. More preferentially, A is a divalent group comprising at least an aliphatic portion and an aromatic portion of arylene-dialkylene or alkylene-diarylene type; and A is especially preferentially a phenylene-dialkylene group (such as phenylene-dimethylene or phenylene-diethylene) or an alkylene-diphenylene group (such as methylene-diphenylene).

Preferably, when A is interrupted, it is interrupted by at least one heteroatom chosen from oxygen, nitrogen and sulfur, preferably oxygen.

According to a preferential embodiment, A is substituted by at least one radical chosen from alkyl, cycloalkylalkyl, aryl, aralkyl, hydroxyl, alkoxy, amino and carbonyl radicals.

The radicals R₁, R₂, R₃ and R₄ independently represent identical or different groups chosen from the hydrogen atom, alkyls having from 1 to 20 carbon atoms, cycloalkyls having from 5 to 24 carbon atoms, aryls having from 6 to 30 carbon atoms and aralkyls having from 7 to 25 carbon atoms; groups which may optionally be interrupted by one or more heteroatoms and/or substituted, R₁ and R₂ on the one hand and R₃ and R₄ on the other hand possibly forming, together with the carbon atoms of the ring to which they are attached, a ring chosen from aromatic, heteroaromatic or aliphatic rings comprising from 5 to 12 carbon atoms, preferably 5 or 6 carbon atoms. Preferably, R₁, R₂, R₃ and R₄ independently represent identical or different groups chosen from the hydrogen atom and linear or branched alkyls having from 1 to 6 carbon atoms; groups which may optionally be substituted.

According to a preferred embodiment, A is substituted by one or more radicals of formula (II) and/or by one or more hydrocarbon-based radicals chosen from alkyl, cycloalkyl, cycloalkylalkyl, aryl or aralkyl radicals, themselves substituted by one or more radicals of formula (II)

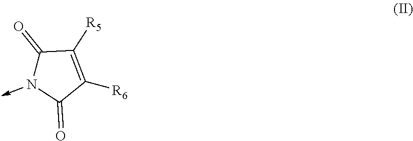

in which the arrow represents the point of attachment to the rest of the group A; and R₅ and R₆ independently represent identical or different groups chosen from the hydrogen atom and hydrocarbon-based groups, R₅ and R₆ possibly forming, together with the carbon atoms of the ring to which they are attached, a ring. Preferably, R₅ and R₆ independently represent identical or different groups chosen from the hydrogen atom and linear or branched alkyls having from 1 to 6 carbon atoms.

Also according to a preferred embodiment of the invention, A does not comprise other radicals of formula (II) as represented above.

Preferably, in the composition contained in the tire according to the invention, the content of polydienophile is within a range extending from 0.2 to 100 phr and preferably from 0.2 to 50 phr. This is because, below 0.2 phr of polydienophile, the effect of the crosslinking is not substantial, whereas, above 100 phr of polydienophile, the polydienophile, the crosslinking agent, becomes predominant by weight relative to the polymer matrix. Thus, preferentially, the content of polydienophile is within a range extending from 0.4 to 27 phr and preferably from 0.9 to 20 phr.

The polydienophiles of use for the requirements of the invention are either commercially available or readily prepared by those skilled in the art according to well-known techniques, such as the routes described for example in the document Walter W. Wright and Michael Hallden-Abberton “Polyimides” in Ullmann's Encyclopedia of Industrial Chemistry, 2002, Wiley-VCH, Weinheim. doi:10.1002/14356007.a21_253.

For example, as commercially available polydienophiles of use for the requirements of the invention, mention may be made of bismaleimides and biscitraconimides.

I.4. Various Additives

The rubber compositions of the tires in accordance with the invention can also comprise all or a portion of the usual additives generally used in elastomer compositions intended for the manufacture of treads, such as, for example, pigments, protection agents, such as antiozone waxes, chemical antiozonants or antioxidants, antifatigue agents, crosslinking agents other than those mentioned above, reinforcing resins or plasticizing agents. Preferably, this plasticizing agent is a solid hydrocarbon-based resin (or plasticizing resin), an extending oil (or plasticizing oil) or a mixture of the two.

These compositions may also contain, in addition to the coupling agents, coupling activators, agents for covering the inorganic fillers or more generally processing aids capable, in a known manner, by virtue of an improvement in the dispersion of the filler in the rubber matrix and of a lowering of the viscosity of the compositions, of improving their ability to be processed in the raw state, these agents being, for example, hydrolysable silanes, such as alkylalkoxysilanes, polyols, polyethers, primary, secondary or tertiary amines, or hydroxylated or hydrolysable polyorganosiloxanes.

Preferentially, the compositions of the tires of the invention are devoid of a crosslinking system other than that described above and which comprises a polydienophile. In other words, the crosslinking system based on at least one polydienophile is preferentially the only crosslinking system in the composition of the tire of the invention. Thus, the composition of the tire according to the invention is preferentially devoid of molecular sulfur or contains less than 1 phr, preferably less than 0.5 phr and more preferentially less than 0.2 phr thereof. Likewise, the composition is preferentially devoid of any vulcanization accelerator as known to those skilled in the art or contains less than 1 phr, preferably less than 0.5 phr and more preferentially less than 0.2 phr thereof. Preferably, the compositions of the tires of the invention are devoid of a vulcanization system or contain less than 1 phr, preferably less than 0.5 phr and more preferentially less than 0.2 phr thereof.

I.5. Preparation of the Rubber Compositions

The compositions used in the tires of the invention can be manufactured in appropriate mixers, using two successive phases of preparation well known to those skilled in the art: a first phase of thermomechanical working or kneading (“non-productive” phase) at high temperature, up to a maximum temperature of between 110° C. and 200° C., preferably between 130° C. and 180° C., followed by a second phase of mechanical working (“productive” phase) down to a lower temperature, typically of less than 110° C., for example between 40° C. and 100° C., during which finishing phase the crosslinking system may be incorporated.

Preferably, for the implementation of the invention, all the constituents of the composition are introduced into the internal mixer, so that the incorporation of a vulcanization system during the “productive” phase above can be dispensed with. This is because the crosslinking system of the compositions of the invention makes it possible to work the mixture at high temperature, which constitutes a major advantage during the preparation of the compositions of the invention, in comparison with the preparation of the compositions comprising a conventional vulcanization system.

The final composition thus obtained can subsequently be calendered, for example in the form of a sheet or a slab, especially for laboratory characterization, or else extruded, for example in order to form a rubber profiled element used in the manufacture of the tire of the invention.

I.6. Tire of the Invention

The rubber composition of the tire according to the invention can be used in different parts of said tire, especially in the crown, the area of the bead, the area of the sidewall and the tread (especially in the underlayer of the tread).

According to a preferential embodiment of the invention, the rubber composition described above can be used in the tire as an elastomer layer in at least one part of the tire.

Elastomer “layer” is understood to mean any three-dimensional component, made of rubber (or “elastomer”, the two being regarded as synonyms) composition, having any shape and any thickness, especially sheet, strip or other component having any cross section, for example rectangular or triangular.

First of all, the elastomer layer can be used as tread underlayer positioned in the crown of the tire between, on the one hand, the tread, i.e. the portion intended to come into contact with the road during running, and, on the other hand, the belt reinforcing said crown. The thickness of this elastomer layer is preferably within a range extending from 0.5 to 10 mm, especially within a range from 1 to 5 mm.

According to another preferential embodiment of the invention, the rubber composition according to the invention may be used to form an elastomer layer arranged in the region of the area of the bead of the tire, radially between the carcass ply, the bead wire and the turn-up of the carcass ply.

Equally, the composition according to the invention can be used in the plies of the crown (tire belt) or in the area between the ends of the plies of the crown and the carcass ply.

Another preferential embodiment of the invention can be the use of the composition according to the invention to form an elastomer layer positioned in the area of the sidewall of the tire.

Alternatively, the composition of the invention can advantageously be used in the tread of the tire.

II. Exemplary Embodiments of the Invention

The rubber compositions are characterized after curing, as indicated below.

II.1. Tensile Tests

The tensile tests are carried out in accordance with French Standard NF T 46-002 of September 1988. At second elongation (that is to say, after accommodation), the nominal secant modulus, calculated by reducing to the initial cross section of the test specimen, (or apparent stress, in MPa) is measured at 50% elongation (mean deformation), denoted MA50, and 100% and 300% elongation, denoted MA100 and MA300, respectively. The reinforcement index is given by the ratio between the values of MA300 and MA100.

All these tensile measurements are carried out under standard conditions of temperature (23±2° C.) and hygrometry (50±5% relative humidity), according to French Standard NF T 40-101 (December 1979).

The breaking stresses (in MPa) and the elongations at break (in %) can be measured at 23° C.±2° C. according to Standard NF T 46-002.

II.2. Preparation of the Compositions

Two functionalized elastomers (a polyisoprene and an ethylene/butadiene copolymer) bearing anthracene conjugated diene functional groups are prepared beforehand in the manner described below.

### Anthracene-Functionalized Polyisoprene (IR)

{[3-(Anthracen-9-ylmethoxy)-2,4,6-trimethylphenyl]methylidyne}azane oxide (243 mg, 0.66 mmol), of 90 mol % NMR purity, is incorporated in 15 g of Natsyn 2200 polyisoprene (ML(1+4) 100° C.=79, 3,4-units=0.5%, trans-1,4-units=1.9%, cis-1,4-units=97.6%, Mw=1044.103 g/mol, PI=3.6) on an open mill (external mixer at 30° C.). The mixture is homogenized in 15 turnover passes. This mixing phase is followed by a heat treatment (10 min at 120° C.) under a press at a pressure of 10 bar. Analysis by 1H NMR made it possible to determine the molar degree of grafting (0.25 mol %) and the molar grafting yield (83%).

### Anthracene-Functionalized Ethylene/Butadiene Copolymer (EBR)

{[3-(Anthracen-9-ylmethoxy)-2,4,6-trimethylphenyl]methylidyne}azane oxide (896 mg, 2.44 mmol), of 90 mol % NMR purity, is incorporated in 30 g of ethylene/butadiene copolymer (containing 66 mol % of ethylene units and 34 mol % of butadiene units; of Mn=175 000 g/mol and PI=1.79) on an open mill (external mixer at 30° C.). The mixture is homogenized in 15 turnover passes. This mixing phase is followed by a heat treatment (10 min at 110° C.) under a press at a pressure of 10 bar. Analysis by 1H NMR made it possible to determine the molar degree of grafting (0.29 mol %) and the molar grafting yield (97%).

### Preparation of the Compositions

The following tests are carried out in the following way: the diene elastomer comprising conjugated diene functions, the reinforcing filler, the polydienophile and the other additives are successively introduced into an internal mixer (final degree of filling: approximately 70% by volume), the initial vessel temperature of which is approximately 60° C. Thermomechanical working is then performed (non-productive phase) in one step, which lasts in total for approximately 3 to 4 min, until a maximum “dropping” temperature of 160° C. is reached.

The mixture thus obtained is recovered and cooled, and the compositions thus obtained are subsequently calendered, either in the form of slabs (thickness from 2 to 3 mm) or of thin sheets of rubber, for the measurement of their physical or mechanical properties, or extruded in the form of a profiled element.

### Tests

These tests illustrate rubber compositions which can be used in particular as tread of the tire of the invention. These compositions have an ease of preparation and a simplicity superior to a conventional rubber composition (vulcanized with sulfur), while also improving the reinforcement index of the compositions in comparison with the compositions vulcanized with sulfur.

For this, rubber compositions were prepared as indicated above, some in accordance with the invention (A1 and B1) and some not in accordance (controls A0 and B0), as indicated in tables 1 and 3.

Compositions A0 and B0 are vulcanized compositions (that is to say, crosslinked by a sulfur-based vulcanization system conventional for the curing of tires), whereas compositions A1 and B1 are compositions crosslinked by a polydienophile according to the invention.

The properties of the compositions were measured as indicated above and the results are shown in tables 2 and 4.

TABLE 1

| | A-0 | A-1 |
|---|---|---|
| Polyisoprene (1) | 100 | — |
| Functional polyisoprene (2) | — | 100 |
| Silica (3) | 60 | 60 |
| Antioxidant (4) | 3 | 3 |
| Paraffin | 1 | 1 |
| Silane (5) | 4.5 | 4.5 |
| ZnO (6) | 2.7 | — |
| Stearic acid (7) | 2.5 | — |
| Sulfur | 1.3 | — |
| Accelerator (8) | 1.6 | — |
| Bismaleimide (9) | — | 2.5 |

(1) Polyisoprene, Natsyn 2200 from Goodyear
(2) Anthracene-functionalized polyisoprene (IR) as described above
(3) Silica, Zeosil 1165 MP from Solvay-Rhodia
(4) N- (1,3-Dimethylbutyl)-N-phenyl-para-phenylenediamine (Santoflex 6-PPD from Flexsys)
(5) Silane coupling agent, Si69 from Evonik-Degussa
(6) Zinc oxide (industrial grade - from Umicore)
(7) Stearin (Pristerene 4931 - from Uniqema)
(8) N-Cyclohexyl-2-benzothiazolesulfenamide (Santocure CBS from Flexys)
(9) 1,1′- (Methylenedi-4,1-phenylene)bismaleimide from Sigma-Aldrich

TABLE 2

| | A-0 | A-1 |
|---|---|---|
| MA 50 | 2.09 | 2.04 |
| MA 100 | 1.49 | 1.57 |
| MA 300 | 2.16 | 2.80 |
| MA300/MA100 | 1.45 | 1.78 |

A greater simplicity of the mixture is noted in the compositions of the invention, with fewer ingredients than in the control compositions. Furthermore, it may be noted that the replacement of the conventional vulcanization system by a polydienophile crosslinking system as prescribed for the invention makes it possible to obtain an improvement in the reinforcement index compared to the vulcanized control.

TABLE 3

| | B-0 | B-1 |
|---|---|---|
| EBR (1) | 100 | — |
| Functional EBR (2) | — | 100 |
| Silica (3) | 60 | 60 |
| Antioxidant (4) | 3 | 3 |
| Paraffin | 1 | 1 |
| Silane (5) | 4.5 | 4.5 |
| ZnO (6) | 2.7 | — |
| Stearic acid (7) | 2.5 | — |
| Sulfur | 0.9 | — |
| Accelerator (8) | 1.1 | — |
| Bismaleimide (9) | — | 2.5 |

(1) Ethylene/butadiene copolymer containing 66 mol % of ethylene units and 34 mol % of butadiene units; of Mn = 175 000 g/mol and PI = 1.79)
(2) Anthracene-functionalized ethylene/butadiene copolymer (EBR) as described above
(3) Silica, Zeosil 1165 MP from Solvay-Rhodia
(4) N- (1,3-Dimethylbutyl)-N-phenyl-para-phenylenediamine (Santoflex 6-PPD from Flexsys)
(5) Silane coupling agent, Si69 from Evonik-Degussa
(6) Zinc oxide (industrial grade - from Umicore)
(7) Stearin (Pristerene 4931 - from Uniqema)
(8) N-Cyclohexyl-2-benzothiazolesulfenamide (Santocure CBS from Flexys)
(9) 1,1′- (Methylenedi-4,1-phenylene)bismaleimide from Sigma-Aldrich

TABLE 4

| | B-0 | B-1 |
|---|---|---|
| MA 50 | 4.62 | 4.39 |
| MA 100 | 3.97 | 3.20 |
| MA 300 | 6.80 | 5.46 |
| MA300/MA100 | 1.71 | 1.71 |

A greater simplicity of the mixture is noted in the compositions of the invention, with fewer ingredients than in the control compositions. Furthermore, it may be noted that the replacement of the conventional vulcanization system by a polydienophile crosslinking system as prescribed for the invention makes it possible to obtain a reinforcement index which is as good as that of the vulcanized control, despite saving on a number of ingredients.

1. A tire comprising a rubber composition based on at least a reinforcing filler, a polymer comprising conjugated diene functions and a system for crosslinking said polymer comprising a polydienophile of general formula (I): 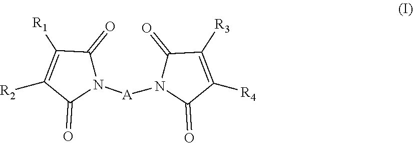
in which:
A represents a covalent bond or a hydrocarbon-based group comprising at least 1 carbon atom, which is optionally substituted and optionally interrupted by one or more heteroatoms,
R₁, R₂, R₃ and R₄ independently represent identical or different groups chosen from the hydrogen atom and hydrocarbon-based groups, R₁, R₂, R₃ and R₄ possibly forming, together with the carbon atoms of the ring to which they are attached, a ring.

2. A tire according to claim 1, in which A represents a covalent bond or a divalent hydrocarbon-based group comprising from 1 to 1800 carbon atoms.

3. (canceled)

4. (canceled)

5. (canceled)

6. A tire according to claim 1, in which A is a divalent group of aliphatic or aromatic type or a group comprising at least an aliphatic portion and an aromatic portion.

7. (canceled)

8. A tire according to claim 1, in which A is a divalent group comprising at least an aliphatic portion and an aromatic portion of arylene-dialkylene or alkylene-diarylene type.

9. (canceled)

10. A tire according to claim 1, in which A is interrupted by at least one heteroatom chosen from oxygen, nitrogen and sulfur.

11. A tire according to claim 1, in which A is substituted by at least one radical chosen from alkyl, cycloalkylalkyl, aryl, aralkyl, hydroxyl, alkoxy, amino and carbonyl radicals.

12. A tire according to claim 1, in which R₁, R₂, R₃ and R₄ independently represent identical or different groups chosen from the hydrogen atom, alkyls having from 1 to 20 carbon atoms, cycloalkyls having from 5 to 24 carbon atoms, aryls having from 6 to 30 carbon atoms and aralkyls having from 7 to 25 carbon atoms; groups which may optionally be interrupted by one or more heteroatoms and/or substituted, R₁, R₂, R₃ and R₄ possibly forming, together with the carbon atoms of the ring to which they are attached, a ring chosen from aromatic, heteroaromatic or aliphatic rings comprising from 5 to 12 carbon atoms.

13. A tire according to claim 1, in which R₁, R₂, R₃ and R₄ independently represent identical or different groups chosen from the hydrogen atom and linear or branched alkyls having from 1 to 6 carbon atoms; groups which may optionally be substituted.

14. A tire according to claim 1, in which A is substituted by one or more radicals of formula (II) and/or by one or more hydrocarbon-based radicals chosen from alkyl, cycloalkyl, cycloalkylalkyl, aryl or aralkyl radicals, themselves substituted by one or more radicals of formula (II): 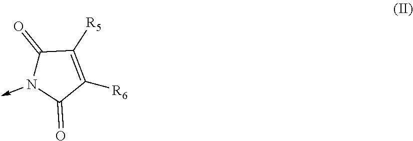
in which:
the arrow represents the point of attachment to the rest of the group A,
R₅ and R₆ independently represent identical or different groups chosen from the hydrogen atom and hydrocarbon-based groups, R₅ and R₆ possibly forming, together with the carbon atoms of the ring to which they are attached, a ring.

15. A tire according to claim 14, in which R₅ and R₆ independently represent identical or different groups chosen from the hydrogen atom and linear or branched alkyls having from 1 to 6 carbon atoms.

16. A tire according to claim 1, in which A does not comprise radicals of formula (II) 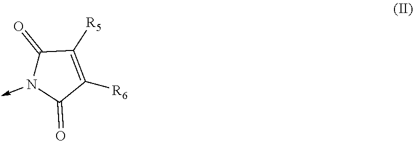
in which:
the arrow represents the point of attachment to the rest of the group A,
R₅ and R₆ independently represent identical or different groups chosen from the hydrogen atom and hydrocarbon-based groups, R₅ and R₆ possibly forming, together with the carbon atoms of the ring to which they are attached, a ring.

17. A tire according to claim 1, in which the content of polydienophile is within a range extending from 0.2 to 100 phr.

18. (canceled)

19. A tire according to claim 1, in which the polymer comprising conjugated diene functions is selected from the group consisting of thermoplastic polymers, elastomers and the mixtures of these.

20. A tire according to claim 1, in which the polymer comprising conjugated diene functions is a diene elastomer comprising conjugated diene functions.

21. A tire according to claim 20, in which the diene elastomer comprising conjugated diene functions is selected from the group consisting of polyisoprenes, polybutadienes, butadiene/styrene copolymers (SBRs) and ethylene/butadiene copolymers (EBRs).

22. A tire according to claim 1, in which the polymer comprising conjugated diene functions comprises conjugated diene functions selected from the group consisting of furans, anthracenes, cyclopentadienes, pyrroles and thiophenes.

23. (canceled)

24. (canceled)

25. A tire according to claim 1, in which the reinforcing filler comprises carbon black, silica or a mixture of carbon black and silica.

26. (canceled)

27. A tire according to claim 1, comprising the rubber composition based on at least a reinforcing filler, a polymer comprising conjugated diene functions and a system for crosslinking said polymer comprising a polydienophile of general formula (I), in which the crosslinking system based on at least one polydienophile is the only crosslinking system in said composition.

28. A tire according to claim 1, in which the composition is devoid of molecular sulfur or contains less than 1 phr.

29. A tire according to claim 1, in which the composition is devoid of any vulcanization accelerator or contains less than 1 phr.
